(19) United States
(12) Patent Application Publication
(10) Pub. No.: US 2016/0140099 A1
(43) Pub. Date: May 19, 2016

(54) TERMINAL APPARATUS

(71) Applicant: FUJI XEROX CO., LTD., Tokyo (JP)

(72) Inventor: Hayato YOSHIKAWA, Kanagawa (JP)

(21) Appl. No.: 14/725,424

(22) Filed: May 29, 2015

(30) Foreign Application Priority Data
Nov. 17, 2014 (JP) 2014-233074

(51) Int. Cl. G06F 17/24; G06F 3/0484

(52) U.S. Cl. CPC G06F 17/243; G06F 3/04842; G06F 17/241

(57) ABSTRACT

A terminal apparatus includes: an installation-time report input display that displays an installation-time report input screen that has an item about an external environment or an internal environment of a target electronic device at the time of installation of the target electronic device; an installation-time report reception unit that receives information on the item about the external environment or the internal environment of the target electronic device; a trouble-time report input display that displays a trouble-time report input screen that has an item about an external environment or an internal environment of the target electronic device at the time of occurrence of a trouble in the target electronic device; a trouble-time report reception unit that receives information on the item about the external environment or the internal environment of the target electronic device; and a selection unit that selects the installation-time report input screen or the trouble-time report input screen.

### CROSS-REFERENCE TO RELATED APPLICATIONS

This application is based on and claims priority under 35 USC 119 from Japanese Patent Application No. 2014-233074 filed Nov. 17, 2014.

### BACKGROUND

### Technical Field

The present invention relates to a terminal apparatus.

### SUMMARY

According to an aspect of the present invention, there is provided a terminal apparatus including: an installation-time report input display that displays an installation-time report input screen that has at least one item about at least one of an external environment and an internal environment of a target electronic device at a time of installation of the target electronic device; an installation-time report reception unit that receives information on the at least one item about the at least one of the external environment and the internal environment of the target electronic device on the basis of the installation-time report input screen displayed by the installation-time report input display; a trouble-time report input display that displays a trouble-time report input screen that has at least one item about at least one of an external environment and an internal environment of the target electronic device at a time of occurrence of a trouble in the target electronic device; a trouble-time report reception unit that receives information on the at least one item about the at least one of the external environment and the internal environment of the target electronic device on the basis of the trouble-time report input screen displayed by the trouble-time report input display; and a selection unit that selects the installation-time report input screen displayed by the installation-time report input display or the trouble-time report input screen displayed by the trouble-time report input display.

### BRIEF DESCRIPTION OF THE DRAWINGS

An exemplary embodiment of the present invention will be described in detail based on the following figures, wherein:

FIG. 1 is a system configuration diagram illustrating a trouble report system according to an exemplary embodiment of the present invention;

FIG. 2 is a schematic view illustrating an image forming device used in the exemplary embodiment of the present invention;

FIG. 3 is a block diagram illustrating a terminal apparatus according to the exemplary embodiment of the present invention;

FIG. 4 is a flowchart illustrating an example of operation of the terminal apparatus 10 according to the exemplary embodiment of the present invention;

FIG. 5 is a plan view illustrating the terminal apparatus according to the exemplary embodiment of the present invention with the terminal apparatus displaying a mode selection screen;

FIG. 6 is a plan view illustrating the terminal apparatus according to the exemplary embodiment of the present invention with the terminal apparatus displaying a report type selection screen;

FIG. 7 is a plan view illustrating the terminal apparatus according to the exemplary embodiment of the present invention with the terminal apparatus displaying a part of an installation-time report input screen;

FIG. 8 is a plan view illustrating the terminal apparatus according to the exemplary embodiment of the present invention with the terminal apparatus displaying another part of the installation-time report input screen;

FIG. 9 is a table illustrating items to be input or acquired at the time of installation;

FIG. 10 is a plan view illustrating the terminal apparatus according to the exemplary embodiment of the present invention with the terminal apparatus displaying a trouble-time report input screen;

FIG. 11 is a plan view illustrating the terminal apparatus according to the exemplary embodiment of the present invention with the terminal apparatus displaying another part of the trouble-time report input screen;

FIG. 12 is a plan view illustrating the terminal apparatus according to the exemplary embodiment of the present invention with the terminal apparatus displaying still another part of the trouble-time report input screen;

FIG. 13 is a plan view illustrating the terminal apparatus according to the exemplary embodiment of the present invention with the terminal apparatus displaying a part of an installation-time report viewing screen;

FIG. 14 is a plan view illustrating the terminal apparatus according to the exemplary embodiment of the present invention with the terminal apparatus displaying a part of a trouble-time report viewing screen;

FIG. 15 is a plan view illustrating the terminal apparatus according to the exemplary embodiment of the present invention with the terminal apparatus displaying another part of the trouble-time report viewing screen; and

FIG. 16 is a screen view illustrating a comparison between the position of a target electronic device when installed and the position of the target electronic device.

### DETAILED DESCRIPTION

Now, an exemplary embodiment of the present invention will be described in detail below with reference to the drawings.

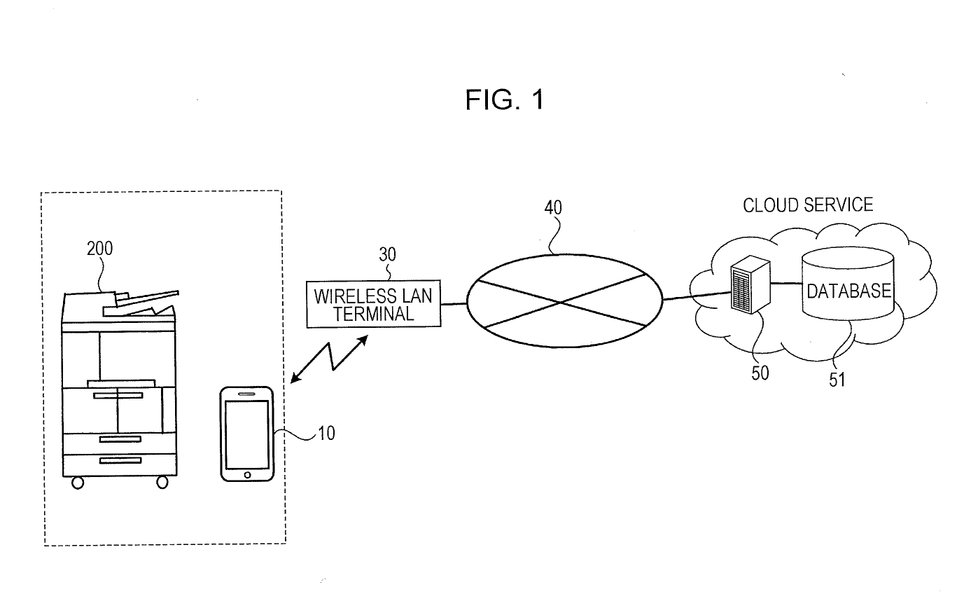

FIG. 1 is a system configuration diagram illustrating a trouble report system according to an exemplary embodiment of the present invention.

As illustrated in FIG. 1, the trouble report system according to the exemplary embodiment of the present invention is composed of a terminal apparatus 10 such as a personal computer, a smartphone, and a tablet terminal apparatus, a server device 50, and a database (information storage device) 51. The server device 50 and the database 51 constitute a parent apparatus that receives a report of trouble information from the terminal apparatus 10.

The present invention may be applied to any terminal apparatus 10 that is capable of reporting trouble information to the server device 50 via a communication network. In the description of the exemplary embodiment, the terminal apparatus 10 is a smartphone that includes a camera that is capable of imaging a location of occurrence of a trouble and a touch panel that enables touch input.

The terminal apparatus 10 acquires information about an external environment and an internal environment of an image forming device 200 that serves as a target electronic device. The terminal apparatus 10 is carried by a service person (maintenance person) who maintains and repairs the image forming device 200 used by an end user, and used to input trouble information and transmit the trouble information to the server device 50, and to view trouble information stored in the database 51 via the server device 50.

The terminal apparatus 10 and the server device 50 are connected to each other via a wireless LAN terminal 30 such as a Wi-Fi router and an Internet communication network 40 to transmit and receive trouble information or the like to and from each other.

In the case where the terminal apparatus 10 is a cellular phone device, a smartphone, or the like, the terminal apparatus 10 and the server device 50 may be connected to each other via a cellular phone network to transmit and receive trouble information to and from each other.

In the trouble report system according to the exemplary embodiment, in the case where the image forming device 200 is installed at the location of an end user, or in the case where a trouble such as a fault and abnormal operation occurs in the image forming device 200, a service person visits the location of the image forming device 200 with the terminal apparatus 10, inputs trouble information such as the model name and the serial number of the product, a description of the trouble, and an image of the location of occurrence of the trouble to the terminal apparatus 10, and transmits the trouble information to the server device 50 via the wireless LAN terminal 30 and the Internet communication network 40.

Then, the server device 50 stores and saves the received installation-time information and trouble information in the database 51, and searches the database 51 and transfers relevant trouble information to the terminal apparatus 10 in response to a viewing request from the terminal apparatus 10.

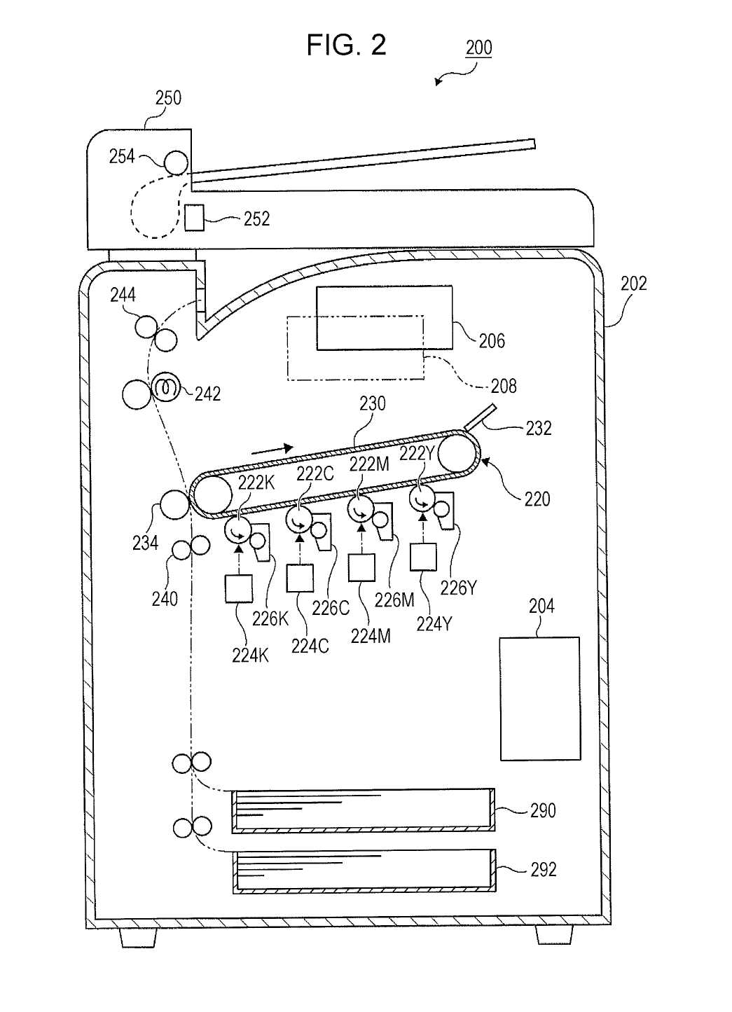

FIG. 2 illustrates a specific example of the image forming device 200. The image forming device 200 has an image forming device body 202. A power source section 204 and a controller 206 are disposed in the image forming device body 202. In addition, a display device 208 is mounted to a side plate on the front side, for example, of the image forming device body 202. The display device 208 displays information about the image forming device 200 such as the location of occurrence of a trouble in the image forming device 200, for example.

In addition, a toner image forming section 220 that forms a toner image, a first paper feed device 290 that feeds paper to the toner image forming section 220, and a second paper feed device 292 that also feeds paper to the toner image forming section 220 are disposed in the image forming device body 202.

The toner image forming section 220 includes: photosensitive drums 222Y, 222M, 222C, and 222K; exposure devices 224Y, 224M, 224C, and 224K that radiates light to the respective photosensitive drums to form a latent image on the respective photosensitive drums; a developing device 226Y that develops the latent image formed on the photosensitive drum 222Y using yellow toner; a developing device 226M that develops the latent image formed on the photosensitive drum 222M using magenta toner; a developing device 226C that develops the latent image formed on the photosensitive drum 222C using cyan toner; and a developing device 226K that develops the latent image formed on the photosensitive drum 222K using black toner.

The toner image forming section 220 additionally includes: a transfer belt 230 to which toner images are transferred from the photosensitive drums 222Y, 222M, 222C, and 222K; a cleaning device 232 that cleans the transfer belt 230; and a second transfer device 234 that further transfers the toner images from the transfer belt 230 to paper.

In addition, a register roller 240, a fixing device 242, and an ejection roller 244 are provided in the image forming device body 202. The register roller 240 is used to control the timing at which paper is transported to a position at which the toner images are transferred from the transfer belt 230 to the paper. The fixing device 242 fixes the toner images which have been transferred to the paper to the paper. The ejection roller 244 ejects the paper to which the toner images have been fixed to the outside of the image forming device body 20.

The image forming device 200 additionally includes a document reading device 250 that includes a document reading section 252 and a document feed device 254. The document reading section 252 reads a document. The document feed device 254 feeds the document to the document reading section 252.

Each portion of the image forming device 200 described above is occasionally subjected to a trouble such as a fault and expiration of the service life. In the case where a trouble occurs in a portion of the image forming device 200, the location of occurrence of the trouble and the description of the trouble which has occurred may be displayed on the display device 208 using a code determined in advance.

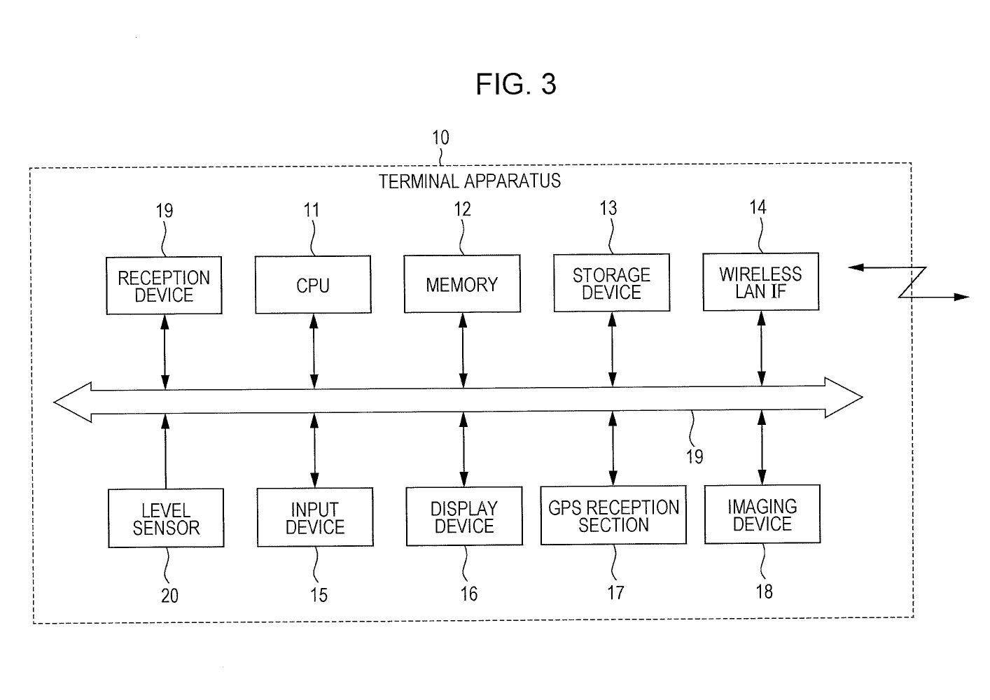

Next, the hardware configuration of the terminal apparatus 10 in the trouble report system according to the exemplary embodiment is illustrated in FIG. 3.

As illustrated in FIG. 3, the terminal apparatus 10 includes a CPU 11, a memory 12 that is capable of temporarily saving data, a storage device 13 such as a flash memory, a wireless LAN interface (IF) 14 that performs wireless communication with the wireless LAN terminal 30 to transmit and receive data to and from the wireless LAN terminal 30, an input device 15 such as a touch sensor, a display device 16, a global positioning system (GPS) reception section 17, and an imaging device 18 such as a camera. Such components are connected to each other via a control bus 19.

The GPS reception section 17 detects the current position of the terminal apparatus 10. The GPS reception section 17 receives and processes radio waves from three or more GPS satellites that orbit the Earth, for example, to detect the current position of the terminal apparatus 10 as position information composed of latitude information and longitude information, for example.

The CPU 11 controls operation of the terminal apparatus 10 by executing a predetermined process on the basis of a control program stored in the memory 12 or the storage device 13. The control program may be downloaded via the Internet communication network 40 or the cellular phone network to be provided to the CPU 11.

The terminal device 10 further includes a reception device 19. The reception device 19 communicates with the controller 206 of the image forming device 200 using Bluetooth (registered trademark), infrared communication, or the like, for example, to receive information accumulated in the image forming device 200. The terminal device 10 additionally includes a level sensor 20. The level sensor 20 is capable of detecting whether or not the image forming device 200 is installed horizontally when the terminal apparatus 10 is placed on a portion of the image forming device 200 that should be horizontal.

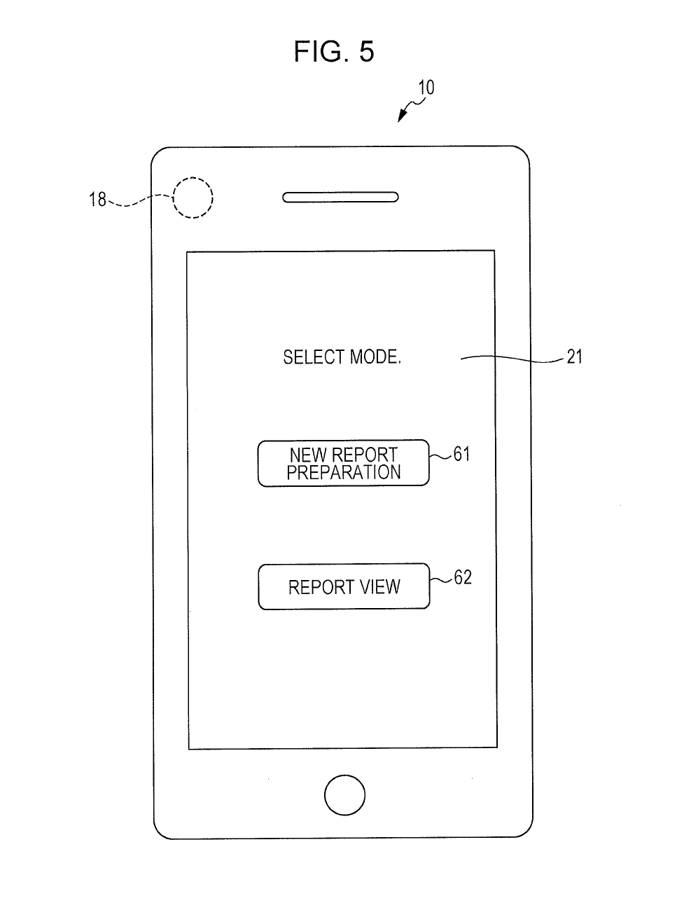

As illustrated in FIG. 5, for example, the terminal apparatus 10 includes a touch panel section 21 that functions as the input device 15 and the display device 16 discussed earlier. In addition, the imaging device 18 which captures an image is provided to the terminal apparatus 10 on the side opposite to the touch panel section 21.

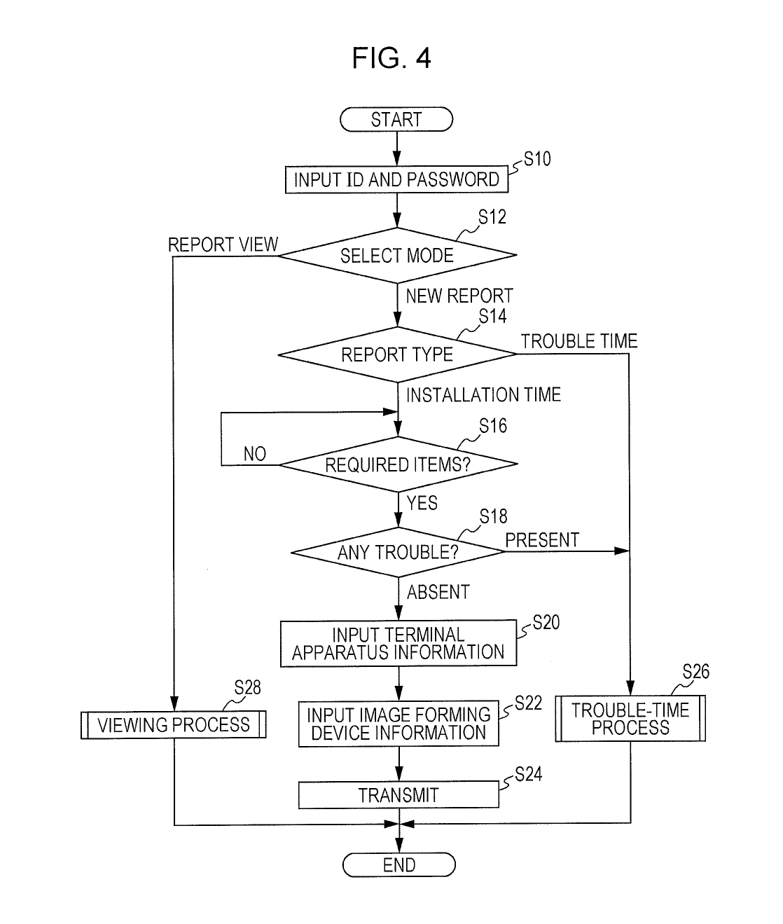

Next, an example of operation of the terminal apparatus 10 will be described with reference to the flowchart illustrated in FIG. 4.

First, when a report application is launched, it is requested in step S10 to input an ID and a password. When an ID and a password are input, the process proceeds to step S12. In step S12, it is determined whether the terminal apparatus 10 is in a new report preparation mode or a report view mode. In step S12, as illustrated in FIG. 5, a new report button 61 and a report view button 62 are displayed on the touch panel section 21. In the case where the new report button 61 is selected, it is determined that the terminal apparatus 10 is in the new report preparation mode. In the case where the report view button 62 is selected, it is determined that the terminal apparatus 10 is in the report view mode.

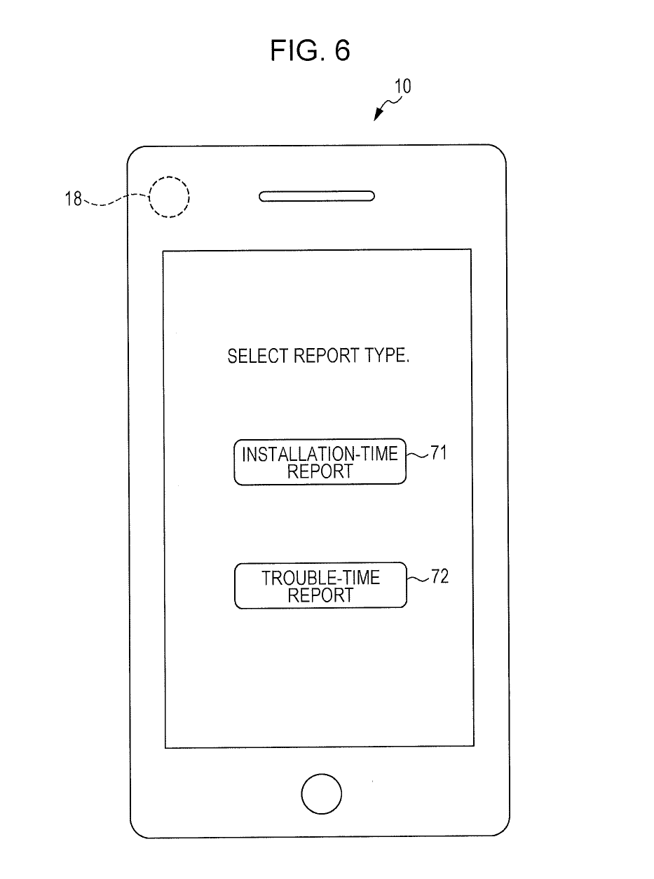

When the new report preparation mode is determined in step S12, the process proceeds to the next step S14. In step S14, it is determined whether the report type is an installation-time report or a trouble-time report. In step S14, as illustrated in FIG. 6, an installation-time report button 71 and a trouble-time report button 72 are displayed on the touch panel section 21. In the case where the installation-time report button 71 is selected, an installation-time report is determined. In the case where the trouble-time report button 72 is selected, a trouble-time report is determined.

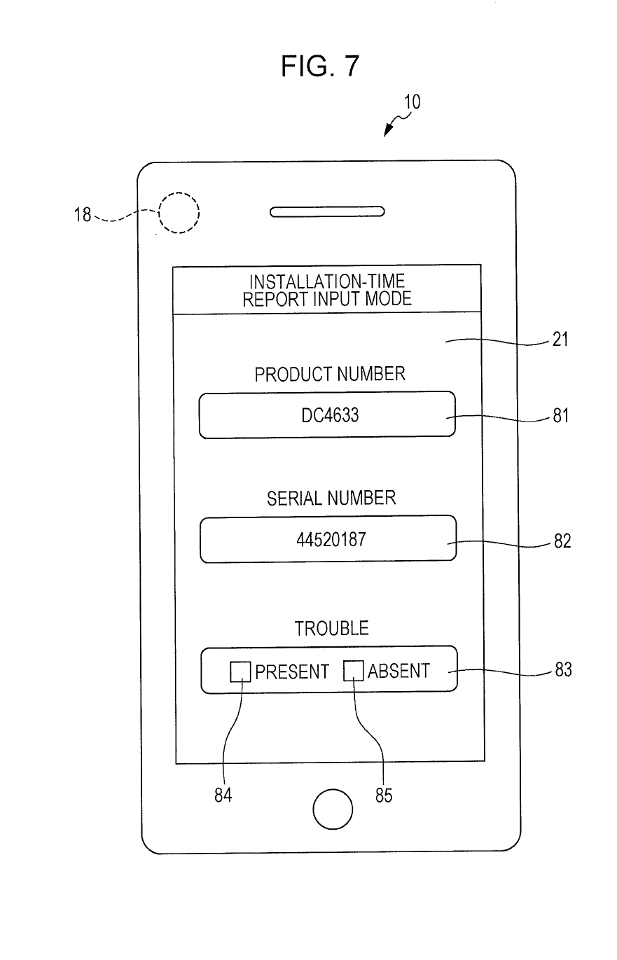

When an installation-time report is determined in step S14, the process proceeds to the next step S16. In step S16, it is determined whether or not input of required items has been finished. In step S16, as illustrated in FIG. 7, the touch panel section 21 displays an installation-time report input screen. The installation-time report input screen is provided with a product number input portion 81, a serial number input portion 82, and a trouble presence/absence input portion 83. The product number of the image forming device 200 discussed earlier is input to the product number input portion 81. The serial number of the image forming device 200 is input to the serial number input portion 82. The trouble presence/absence input portion 83 is provided with select portions 84 and 85 that allow selection of “Present” and “Absent”, respectively.

The product number and the serial number are input by an operator using a keyboard or the like. In the case where the product number and the serial number are stored in the controller 206 of the image forming device 200, however, the product number and the serial number may be automatically input via the reception device 19 discussed earlier.

When the product number, the serial number, and the presence or absence of a trouble are input as the required items in step S16, the process proceeds to the next step S18. In step S18, it is determined which of “Present” and “Absent” has been input using the trouble presence/absence input portion 83.

In the case where it is determined in step S18 that a trouble is absent, the process proceeds to the next step S20. In step S20, information possessed by the terminal apparatus 10 is acquired. The information possessed by the terminal apparatus 10 includes time information, position information received by the GPS reception section 17 discussed earlier, and information indicating whether or not the image forming device 200 is installed horizontally detected by the level sensor 20. The information possessed by the terminal apparatus 10 may further include the altitude, the temperature, and the humidity.

In the next step S22, information possessed by the image forming device 200 is acquired. The information possessed by the image forming device 200 includes information about the external environment such as the temperature and the humidity, and information about the internal environment such as the product number, the date of manufacture, the manufacturer, and the date of replacement of the photosensitive drums, a toner box, the transfer belt, etc. The information possessed by the image forming device 200 may further include version information on software for the controller 206.

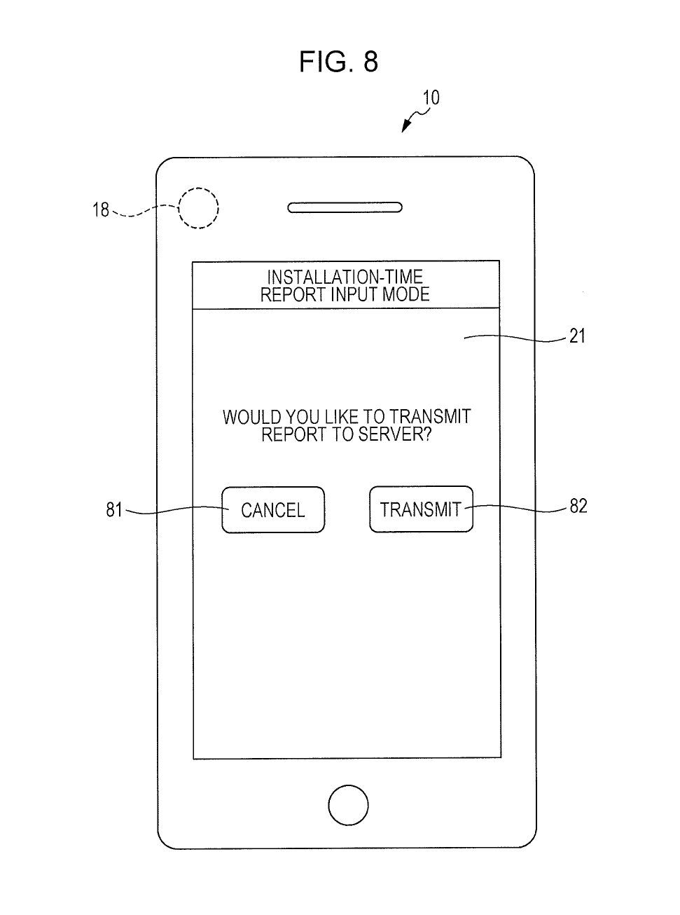

In the next step S24, the input information input in step S16, the terminal apparatus information acquired in step S20, and the image forming device information acquired in step S22 are transmitted collectively. In this case, as illustrated in FIG. 8, a cancel button 91 and a transmit button 92 are displayed on the touch panel section 21 by scrolling the installation-time report input screen. When the cancel button 91 is selected, the screen returns to the mode select screen illustrated in FIG. 5. When the transmit button 92 is selected, the information is sent to the server device 50 via the wireless LAN interface (IF) 14 to be stored in the database 51.

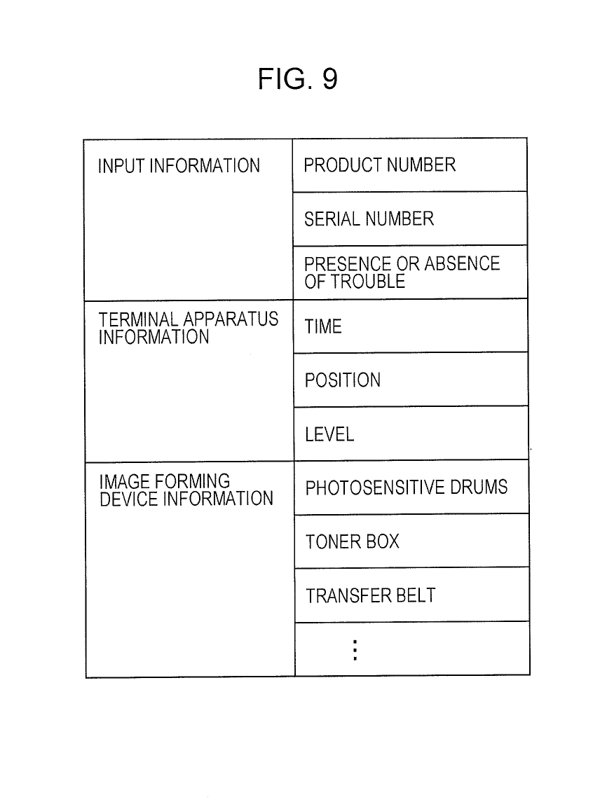

That is, as illustrated in FIG. 9, the transmitted information includes: the product number, the serial number, and the presence or absence of a trouble as the input information; the time, the position, and whether or not horizontal as the terminal apparatus information; and the information about the photosensitive drums, the toner box, the transfer belt, etc. as the image forming device information.

In the case where it is determined in step S14 that the report type is a trouble-time report (in the case where the trouble-time report button 72 in FIG. 6 is selected), the process proceeds to a trouble-time process in step S26. Also in the case where it is determined in step S18 that a trouble is present (in the case where the select portion 84 in FIG. 7 is selected), the process proceeds to the trouble-time process in step S26.

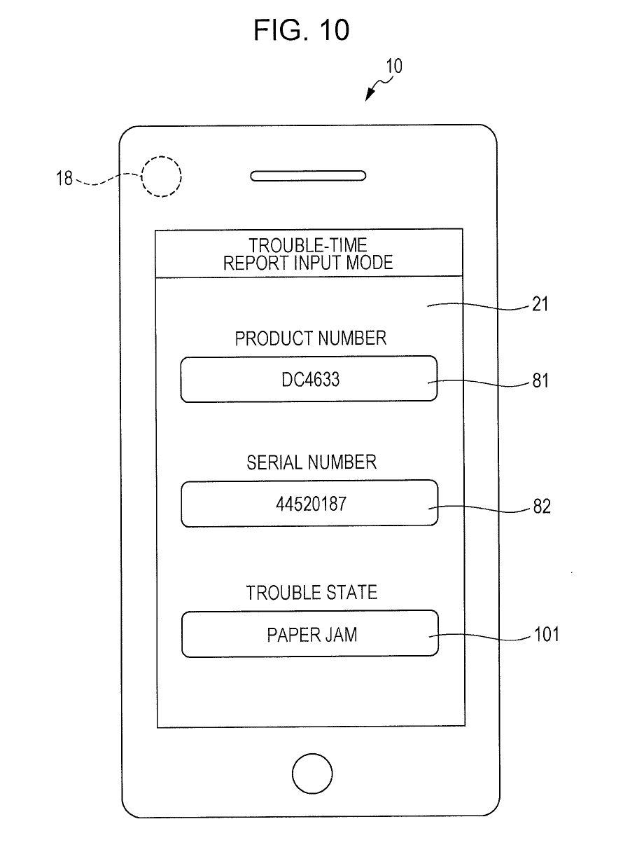

In the trouble-time process, as illustrated in FIG. 10, the touch panel section 21 of the terminal apparatus 10 first displays a trouble-time report input screen. The trouble-time report input screen is provided with a product number input portion 81, a serial number input portion 82, and a trouble state input portion 101. The location of occurrence of the trouble is input to the trouble state input portion 101. The trouble-time report input screen is the same as the installation-time report input screen illustrated in FIG. 7 in having the product number input portion 81 and the serial number input portion 82, and different from the installation-time report input screen in not having the trouble presence/absence input portion 83 provided in the installation-time report input screen.

When the product number is input to the product number input portion 81, the associated serial number etc. is called up from the server device 50 so that the serial number is automatically input to the serial number input portion 82.

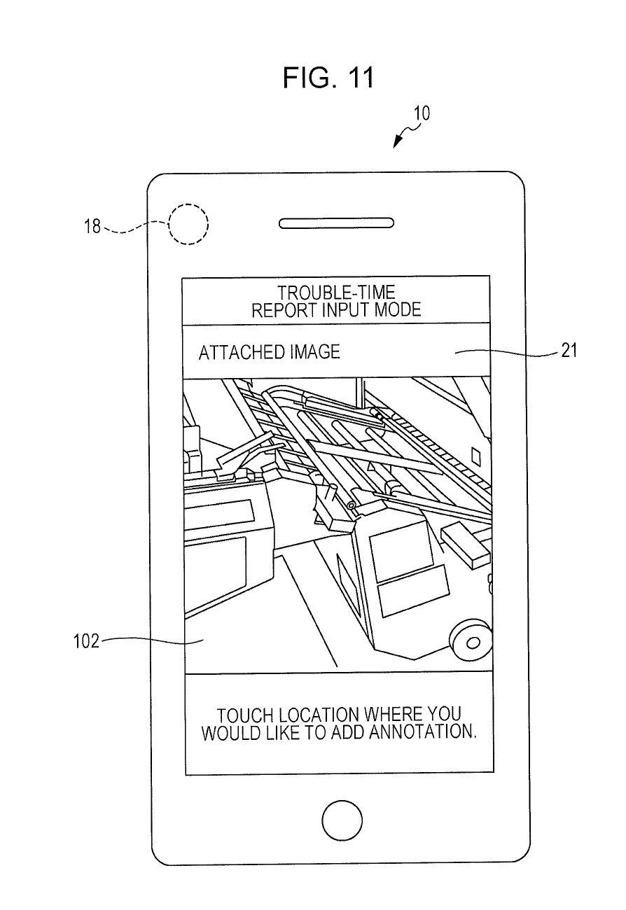

When the screen is scrolled downward from the state illustrated in FIG. 10, in addition, an attached image 102 may be input as illustrated in FIG. 11. That is, the location of the trouble may be imaged using the imaging device 18 discussed earlier to capture the image as an attached image. In addition, the attached image 102 may be provided with an indication of the specific location of the trouble, a description of the trouble, etc. as an annotation.

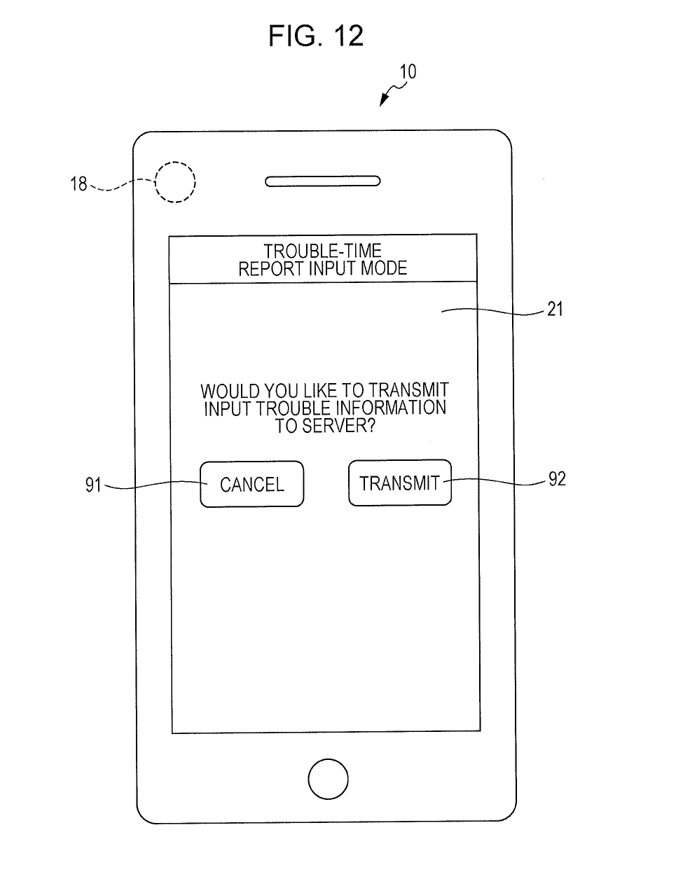

Then, when the screen is scrolled downward from the state illustrated in FIG. 11, a cancel button 91 and a transmit button 92 are displayed on the touch panel section 21 as illustrated in FIG. 12. When the cancel button 91 is selected, the screen returns to the mode select screen illustrated in FIG. 5. When the transmit button 92 is selected, the trouble information is sent to the server device 50 via the wireless LAN interface (IF) 14 to be stored in the database 51.

Also in the case where the trouble-time information is transmitted, as with the installation-time information, the various kinds of information including the position information illustrated in FIG. 9 (excluding the information as to the presence or absence of a trouble) are transmitted at the same time.

In the case where the report view mode is determined (the report view button 62 in FIG. 5 is selected) in step S12, the process proceeds to a viewing process in step S28.

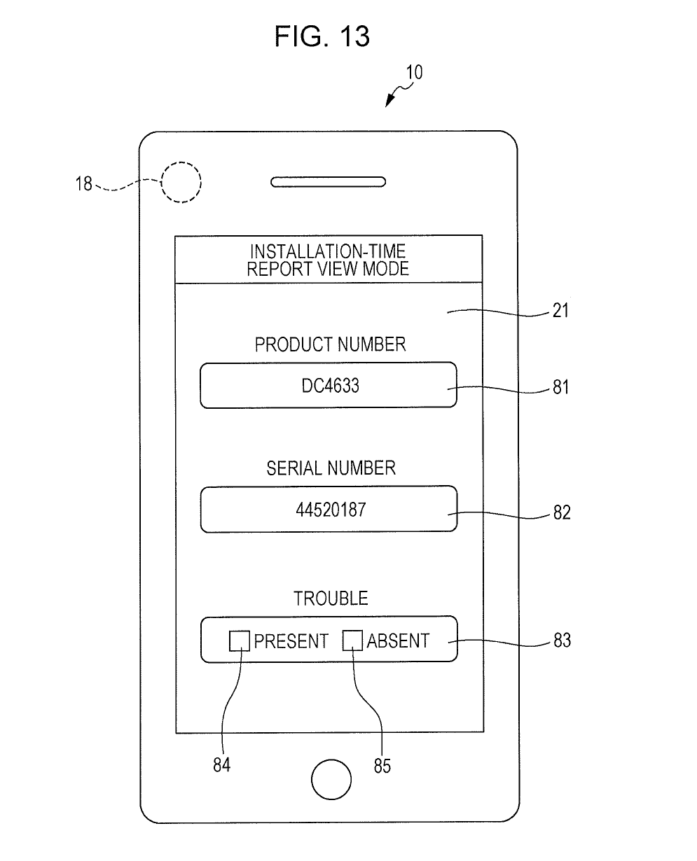

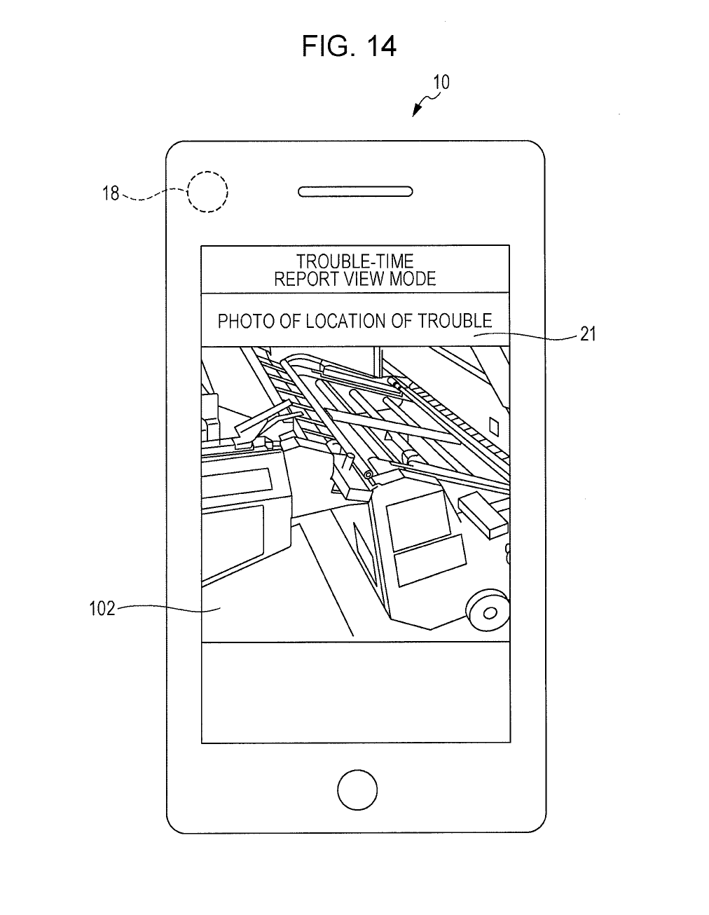

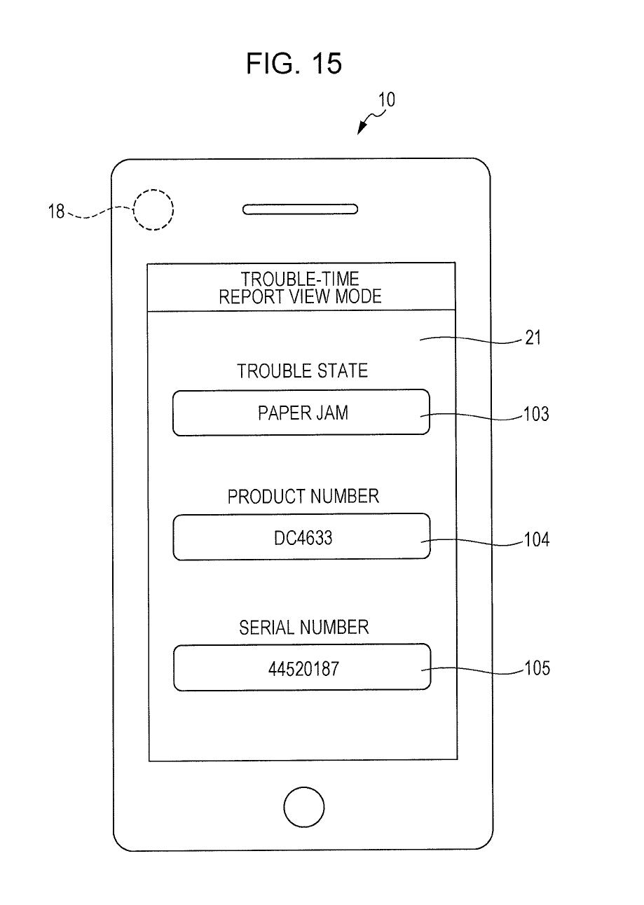

In the viewing process, first, a report type is selected as illustrated in FIG. 6. In the case where the installation-time report button 71 is selected, an installation-time report view screen illustrated in FIG. 13 is displayed. In addition, the various kinds of information illustrated in FIG. 9 are displayed. In the case where the trouble-time report button 72 is selected, on the other hand, a trouble-time report view screen illustrated in FIGS. 14 and 15 is displayed. The trouble-time report view screen is different from the trouble-time report input screen discussed earlier in the display order of the image. In the trouble-time report view screen, the attached image 102 is first displayed, and followed by the trouble state display portion 103, the product number display portion 104, and the serial number display portion 105. In addition, the various kinds of information including the position information illustrated in FIG. 9 (excluding the information as to the presence or absence of a trouble) are displayed on the trouble-time report view screen.

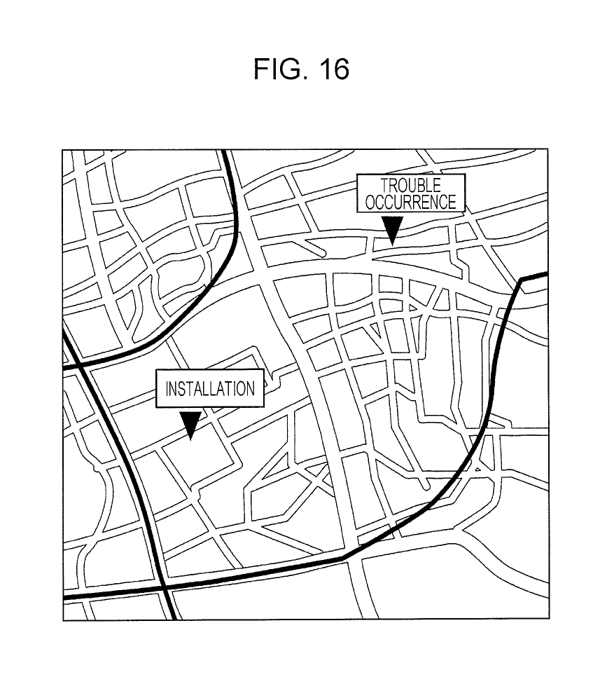

In the exemplary embodiment described above, one of the installation-time report view screen and the trouble-time report view screen is selected to be viewed. However, the various kinds of information may be displayed in comparison with each other. For example, as illustrated in FIG. 16, the position information at the time of installation and the position information at the time of occurrence of a trouble may be displayed for comparison on a map acquired by the server. It is estimated from such display that the trouble may have been caused when the image forming device was moved from the location of installation. In addition, the table illustrated in FIG. 9 at the time of installation and the counterpart at the time of occurrence of a trouble may be arranged side by side. In this case, information that is different between the time of installation and the time of occurrence of a trouble may be colored, shaded, etc. for differentiation.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A terminal apparatus comprising:
an installation-time report input display that displays an installation-time report input screen that has at least one item about at least one of an external environment and an internal environment of a target electronic device at a time of installation of the target electronic device;
an installation-time report reception unit that receives information on the at least one item about the at least one of the external environment and the internal environment of the target electronic device on the basis of the installation-time report input screen displayed by the installation-time report input display;
a trouble-time report input display that displays a trouble-time report input screen that has at least one item about at least one of an external environment and an internal environment of the target electronic device at a time of occurrence of a trouble in the target electronic device;
a trouble-time report reception unit that receives information on the at least one item about the at least one of the external environment and the internal environment of the target electronic device on the basis of the trouble-time report input screen displayed by the trouble-time report input display; and
a selection unit that selects the installation-time report input screen displayed by the installation-time report input display or the trouble-time report input screen displayed by the trouble-time report input display.

2. The terminal apparatus according to claim 1,
wherein the installation-time report input screen displayed by the installation-time report input display includes a trouble information reception section that receives whether or not a trouble has occurred at the time of installation, and the selection unit transitions from the installation-time report input screen to the trouble-time report input screen in a case where the trouble information reception section receives occurrence of a trouble.

3. The terminal apparatus according to claim 1,
wherein the installation-time report reception unit and the trouble-time report reception unit receive information on a component of the target electronic device as the information about the internal environment.

4. The terminal apparatus according to claim 1,
wherein the installation-time report reception unit and the trouble-time report reception unit receive information on a position at which the target electronic device is installed as the information about the external environment.

5. A terminal apparatus comprising:
an installation-time view display that displays information on at least one item about at least one of an external environment and an internal environment of a target electronic device at a time of installation of the target electronic device;
a trouble-time view display that displays information on at least one item about at least one of an external environment and an internal environment of the target electronic device at a time of occurrence of a trouble in the target electronic device; and
a selection unit that selects an installation-time view screen displayed by the installation-time view display or a trouble-time view screen displayed by the trouble-time view display.

6. A terminal apparatus comprising:
an installation-time view display that displays information on at least one item about at least one of an external environment and an internal environment of a target electronic device at a time of installation of the target electronic device;
a trouble-time view display that displays information on at least one item about at least one of an external environment and an internal environment of the target electronic device at a time of occurrence of a trouble in the target electronic device; and
a comparison display that displays the information displayed by the installation-time view display and the information displayed by the trouble-time view display such that both are comparable.
